(19) United States
(12) Patent Application Publication
(10) Pub. No.: US 2021/0264389 A1
(43) Pub. Date: Aug. 26, 2021

(54) SYSTEMS AND METHODS FOR PREPAID PAYMENT CARDS AND DIGITAL WALLET

(71) Applicant: Mastercard International Incorporated, Purchase, NY (US)

(72) Inventors: Alexandra Crossfield, St. Peters, MO (US); Rashmi Kanukurthy, O'Fallon, MO (US); Balaji Rao Thummalapenta, Lake St. Louis, MO (US); Tam H. Tran, Overland, MO (US); Suryanarayana Murty Tadala, Lake St. Louis, MO (US)

(73) Assignee: Mastercard International Incorporated, Purchase, NY (US)

(21) Appl. No.: 16/797,002

(22) Filed: Feb. 21, 2020

(51) Int. Cl. G06Q 20/10; G06Q 20/36; G06Q 40/02; G06Q 20/34; G06Q 20/42; G06Q 20/40; G06K 7/06

(52) U.S. Cl. CPC G06Q 20/108; G06Q 20/36; G06Q 40/02; G06F 21/72; G06Q 20/42; G06Q 20/4018; G06K 7/06; G06Q 20/342

(57) ABSTRACT

A computing system has a communication interface for receiving, from a gift bag wallet application operating on a cardholder mobile device, a transfer request to transfer a balance of a prepaid payment card to a cardholder account associated with a cardholder digital wallet. A processor of the mobile device is programmed to determine, from the transfer request, the prepaid payment card issuer and a payment network associated with the prepaid payment card. Using the communication interface, the system transmits, to the prepaid payment card issuer, a balance request message for a balance of the prepaid payment card and receives a balance request response message identifying the balance of the prepaid payment card. The system then transfers the balance of the prepaid payment card from the prepaid payment card issuer to the cardholder account associated with the cardholder digital wallet based on cardholder information of the cardholder account included in the transfer request.

### BACKGROUND OF THE DISCLOSURE

The field of the disclosure relates generally to digital wallets and prepaid payment cards and, more particularly, to systems and methods for aggregating prepaid payment cards in a single digital wallet account.

When purchasing and/or receiving a prepaid payment card (e.g., general-purpose reloadable card, gift card, etc.), for example, for a birthday, holiday, as a gift, etc., it is easy for a cardholder to forget about the card and/or any remaining money left on a card after partial use. In some instance, a cardholder may not have enough space in his or her wallet to carry another payment card. This often leads to a cardholder failing to use the card and/or losing the card altogether.

Furthermore, many prepaid payment cards and/or gift cards have an expiration date, an inactive use fee, or other fees that result in a loss of a portion, or even all of the original value of the card if the card is not used within a specified period. Breakage, which is a term used to describe revenue gained by retailers through unredeemed gift cards or other prepaid cards, is in excess of one billion dollars ($1,000,000,000) per year.

### BRIEF DESCRIPTION OF THE DISCLOSURE

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a computing system is provided. The computing system includes a communication interface for receiving, from a gift bag wallet application operating on a cardholder mobile device, a first transfer request to transfer a balance of a first prepaid payment card from a first prepaid payment card issuer of the first prepaid payment card to a cardholder account associated with a cardholder digital wallet. The computing system also includes one or more processors programmed to determine, from the first transfer request, the first prepaid payment card issuer and a first payment network associated with the first prepaid payment card. The processor is also programmed to transmit, to the first prepaid payment card issuer via the first payment network, a first balance request message for a balance of the first prepaid payment card. Furthermore, the processor is programmed to receive, from the first prepaid payment card issuer via the communication interface, a first balance request response message identifying the balance of the first prepaid payment card. Moreover, the processor is programmed to transfer, using the communication interface, the balance of the first prepaid payment card from the first prepaid payment card issuer to the cardholder account associated with the cardholder digital wallet via the payment network based on cardholder information of the cardholder account included in the first transfer request.

In another aspect, a system having a cardholder mobile computing device and a computing system is provided. The cardholder mobile device includes a transceiver, a photographic element, a memory device for storing a gift bag wallet application and a digital wallet thereon, a display for presenting a user interface to a cardholder, and a first processor. The first processor is coupled in communication to the transceiver, the photographic element, the memory device, and the display. The first processor is programmed to execute the gift bag wallet application. The gift bag wallet application includes a user interface. The computing system includes a communication interface for receiving, from the cardholder mobile computing device, a transfer request to transfer a balance of a prepaid payment card to a cardholder account associated with the digital wallet, and a second processor. The second processor is programmed to determine, from the transfer request, the prepaid payment card issuer and a payment network associated with the prepaid payment card. The second processor is also programmed to package prepaid payment card information and transaction details received in the transfer request into an authorization request message. In addition, the second processor is programmed to transmit, via the payment network using the communication interface, the authorization request message to the prepaid payment card issuer via the payment network, and transfer, via the payment network using the communication interface, the balance of the prepaid payment card from the prepaid payment card issuer to the cardholder account associated with the digital wallet.

In yet another aspect, a method is provided. The method includes receiving, from a gift bag wallet application operating on a cardholder mobile device, a transfer request to transfer a balance of a prepaid payment card from a prepaid payment card issuer of the prepaid payment card to a cardholder account associated with a cardholder digital wallet. The method also includes determining, from the transfer request, the prepaid payment card issuer and a payment network associated with the prepaid payment card. Furthermore, the method includes transmitting, to the prepaid payment card issuer via the payment network, a balance request message for a balance of the prepaid payment card. In addition, the method includes receiving, from the prepaid payment card issuer, a balance request response message identifying the balance of the prepaid payment card. Moreover, the method includes transferring the balance of the prepaid payment card from the prepaid payment card issuer to the cardholder account associated with the cardholder digital wallet via the payment network based on cardholder information of the cardholder account included in the transfer request.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of an example multi-party network system, including a cardholder mobile device belonging to a cardholder, a computing system, and a server system, in accordance with one embodiment of the present disclosure;

FIG. 2 is an example configuration of the cardholder mobile device shown in FIG. 1 that may be operated by a cardholder shown in FIG. 1;

FIG. 3 is an example configuration of a computing system for use in the network system shown in FIG. 1;

FIG. 4 is an example configuration of a server system for use in the network system shown in FIG. 1;

FIG. 5 is a schematic diagram of the user interface of the cardholder mobile device shown in FIG. 1, illustrating a Login Screen presented to the cardholder of FIG. 1 when logging into a gift bag wallet application;

FIG. 6 is a schematic diagram of the user interface of the cardholder mobile device shown in FIG. 1, illustrating a Gift Bag screen presented to the cardholder of FIG. 1 after logging into the gift bag wallet application;

FIG. 7 is a schematic diagram of the user interface of the cardholder mobile device shown in FIG. 1, illustrating a Scan Card screen presented to the cardholder of FIG. 1 after the cardholder initiates a card scanning process;

FIG. 8 is a schematic diagram of the user interface of the cardholder mobile device shown in FIG. 1, illustrating a Card Details screen presented to the cardholder of FIG. 1 after the gift bag wallet application has scanned a physical prepaid payment card;

FIG. 9 is a schematic diagram of the user interface of the cardholder mobile device shown in FIG. 1, illustrating an updated Gift Bag screen presented to the cardholder of FIG. 1 after adding the physical prepaid payment card to the gift bag wallet;

FIGS. 10A and 10B are schematic diagrams of the user interface of the cardholder mobile device shown in FIG. 1, illustrating a Details screen presented to the cardholder of FIG. 1;

FIG. 11 is a schematic diagram of the user interface of the cardholder mobile device shown in FIG. 1, illustrating a PIN screen presented to the cardholder of FIG. 1 after entering a cardholder's PIN or providing a biometric sample for performing a digital wallet transaction;

FIG. 12 is a schematic diagram of the user interface of the cardholder mobile device shown in FIG. 1, illustrating a peer-to-peer screen presented to the cardholder of FIG. 1 for making payments to or transferring funds to another person;

FIG. 13 is a schematic diagram of the user interface of the cardholder mobile device shown in FIG. 1, illustrating a payment screen presented to the cardholder of FIG. 1; and

FIG. 14 is a flowchart illustrating an exemplary computer-implemented method for converting one or more prepaid payment cards into the digital wallet shown in FIG. 1 not having an expiration date, in accordance with one embodiment of the present disclosure.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. It is contemplated that the invention has general application for transferring prepaid payment card balances (i.e., funds) from the prepaid payment card issuer to a digital wallet account of a cardholder possessing the prepaid payment card. The scope of the present invention is defined only by the appended claims, along with the full scope of equivalents to which such claims are entitled. As used herein, the term “prepaid payment card” includes general-purpose reloadable cards, gift cards, retail cards, payroll cards, and the like.

As used herein, the term “database” includes either a body of data, a relational database management system (RDBMS), or both. As used herein, a database includes, for example, and without limitation, a collection of data including hierarchical databases, relational databases, flat file databases, object-relational databases, object oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL. However, any database may be used that enables the systems and methods to operate as described herein.

Embodiments of the present technology relate to systems, methods, and computer-readable media for converting one or more prepaid payment cards into a digital wallet not having an expiration date. As such, the cardholder is able to maintain his or her funds in an account that does not expire. In addition, the cardholder can electronically store the funds in an account owned by the cardholder and therefore can eliminate the chance of losing the physical prepaid payment card, and therefore, the associated funds.

According to one embodiment of the disclosure, a computing system is configured to receive, from a gift bag wallet application operating on a cardholder mobile device, a transfer request to transfer a balance of a prepaid payment card from a prepaid payment card issuer of the prepaid payment card to a cardholder account associated with a cardholder digital wallet. The computing system determines, from the transfer request, the prepaid payment card issuer and a payment network associated with the prepaid payment card. After determining the appropriate payment network and prepaid payment card issuer, the computing system transmits a balance request message to the prepaid payment card issuer for a balance of the prepaid payment card. The prepaid payment card issuer then transmits a balance request response message back to the computing system identifying the balance of the prepaid payment card. Subsequently, the computing system then transfers the balance of the prepaid payment card from the prepaid payment card issuer to the cardholder account associated with the digital wallet based on cardholder information of the cardholder account included in the transfer request.

### Network System

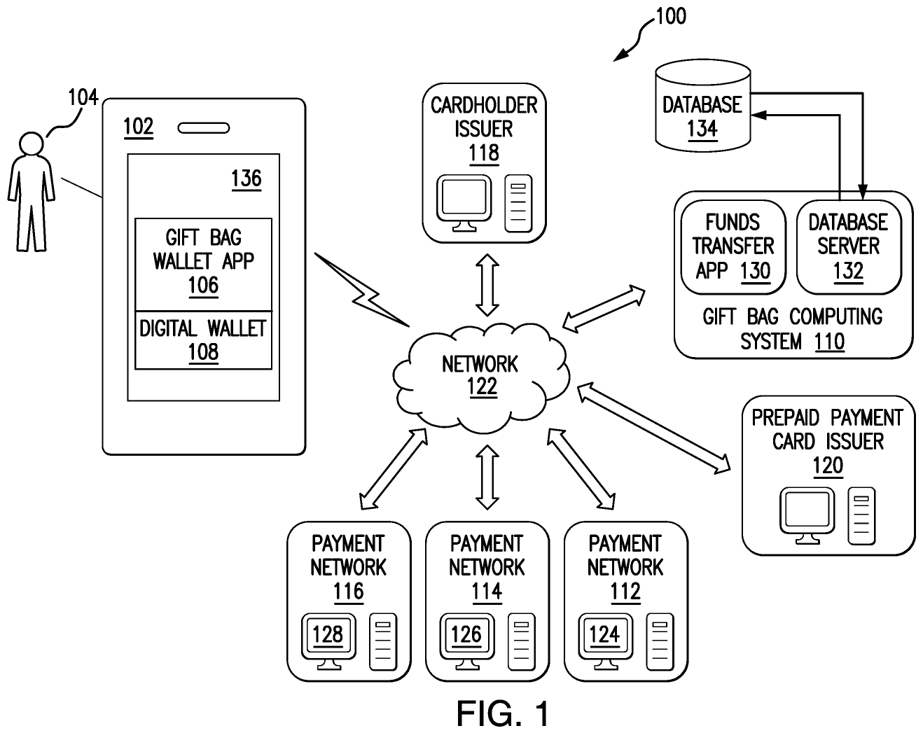

FIG. 1 is a block diagram of an example multi-party network system 100, including a cardholder mobile device 102 belonging to a cardholder 104, in accordance with one embodiment of the present disclosure. In the exemplary embodiment, the network system 100 provides interchange network services offered by one or more payment networks, such as payment networks 112, 114, and 116. In addition, the network system 100 enables payment card transactions in which cardholders 104, issuers (e.g., issuers 118 and 120), and merchants (not shown) do not need to have a one-to-one relationship. Although parts of the network system 100 are presented in one arrangement, other embodiments may include the same or different parts arranged otherwise, depending, for example, on authorization processes for purchase transactions, communication between computing devices, etc.

In the example embodiment, the financial network system 100 generally includes the cardholder mobile device 102, a gift bag computing system 110, the one or more payment networks 112, 114, and 116, and the one or more issuers 118 and 120 (e.g., the cardholder issuer 118 and the prepaid payment card issuer 120) coupled in communication via a communications network 122. The network 122 includes, for example and without limitation, one or more of a local area network (LAN), a wide area network (WAN) (e.g., the Internet, etc.), a mobile network, a virtual network, and/or any other suitable public and/or private network capable of facilitating communication among the cardholder mobile device 102, the gift bag computing system 110, the payment networks 112, 114, and 116, and/or the issuers 118 and 120. In some embodiments, the network 122 includes more than one type of network, such as a private payment transaction network provided by the payment networks 112, 114, and 116 to the issuers 118 and 120. and, separately, the public Internet, which may facilitate communication between the cardholder mobile device 102, the gift bag computing system 110, the payment networks 112, 114, and 116, etc.

Embodiments described herein relate to transaction card systems, such as a credit card payment system using the Mastercard® interchange network. (Mastercard is a registered trademark of Mastercard International Incorporated.) The Mastercard interchange network is a set of proprietary communications standards promulgated by Mastercard International Incorporated for the exchange of financial transaction data and the settlement of funds between financial institutions that are members of Mastercard International Incorporated.

With continued reference to FIG. 1, in the exemplary embodiment, the cardholder mobile device 102 (e.g., a smartphone or other computing device used by the cardholder 104) includes a user interface 136 that facilitates user interaction with the respective cardholder mobile device 102. For example, and without limitation, the user interface 136 enables the cardholder 104 to input information to the cardholder mobile device 102 and the cardholder mobile device 102 to output information to the cardholder 104 (e.g., on a display of the cardholder mobile device 102). The user interface 136 includes, for example, a gift bag wallet app 106 (or financial application), which is installed on the cardholder mobile device 102. In the exemplary embodiment, the gift bag wallet app 106 is associated with the gift bag computing system 110. It is contemplated that fewer or more financial applications may be installed on the cardholder mobile device 102 and displayed by the user interface 136, where each financial application is associated with at least one financial institution (not shown).

In the exemplary embodiment, the cardholder mobile device 102 communicates with the gift bag computing system 110, for example, via the network 122. The gift bag computing system 110 accesses the network 122 to communicate with the issuers 118 and 120, via one or more of the payment networks 112, 114, and 116, to facilitate the exchange of funds and other financial data between accounts of the issuers 118 and 120. In addition, the gift bag wallet app 106 communicates with the cardholder issuer 118 to exchange and/or synchronize financial data with a digital wallet 108, stored by or otherwise accessible to the gift bag wallet app 106.

The cardholder mobile device 102 can be any computing device capable of interconnecting to the network 122, such as the Internet, including a mobile web-based device, smartphone, PDA, or other mobile web-based connectable equipment. The cardholder mobile device 102 is interconnected to the Internet through one or more interfaces including a network, such as a local area network (LAN) or a wide area network (WAN), dial-in-connections, cable modems, wireless modems, and special high-speed ISDN lines. In addition, in the example embodiment, the cardholder mobile device 102 is configured to communicate with other cardholder mobile devices and/or merchant point-of-sale (POS) systems (not shown) using various forms of communication including, for example, radio frequency communication, near field communication (NFC), network-based communication, and the like.

The financial network system 100 includes, for example, and without limitation, a computer, a server, a network of multiple computing devices, a virtual computing device, or the like. In addition, in the exemplary embodiment, the network system 100 also includes one or more payment network server systems 124, 126, and 128 (also referred to as payment systems), which are part of the payment networks 112, 114, and 116, respectively, and are coupled in communication to the network 122. The payment systems 124, 126, and 128 are computers including, for example, a web application, an application programming interface (API) server, and a memory device, enabling the payment systems 124, 126, and 128 to be in communication with the gift bag computing system 110 using, for example, and without limitation, the Internet. The payment systems 124, 126, and 128 are interconnected to the Internet through one or more interfaces including a network, such as a local area network (LAN) or a wide area network (WAN), dial-in-connections, cable modems, and special high-speed ISDN lines. The payment systems 124, 126, and 128 can be any computing device capable of interconnecting to the Internet. In certain embodiments of the present invention, the gift bag computing system 110 is integrated with or is otherwise a part of one of the payment network server systems 124, 126, and 128. In such an embodiment, the gift bag computing system 110 can communicate directly with the payment network server system that it is a part of and communicate with the other payment network server systems via the communication network 122.

The gift bag computing system 110 includes, for example, a database server 132, which is connected to a database 134. In one embodiment, the database 134 is stored on the gift bag computing system 110 and can be accessed by the cardholder 104 by logging onto the gift bag computing system 110, using, for example, the gift bag wallet app 106. In an alternative embodiment, the database 134 may be stored remotely from the gift bag computing system 110 and may be non-centralized. The database 134 is configured to receive and store transaction information related to various financial transactions performed by the cardholder 104, such as converting one or more prepaid payment cards (e.g., redeeming the prepaid payment cards) into a single digital wallet card or account, such as the digital wallet 108.

Furthermore, the gift bag computing system 110 includes a funds transfer application 130. In the exemplary embodiment, the funds transfer application 130 stores, and in some instances, generates, a digital wallet (e.g., the digital wallet 108) for the cardholder 104 on the cardholder mobile device 102. The funds transfer application 130 pulls funds corresponding to a value of a prepaid payment card from the prepaid payment card issuer, such as the prepaid payment card issuer 120 and transfers such funds (e.g., redeems the value of the prepaid payment card) to the account associated with the digital wallet of the cardholder 104, such as the digital wallet 108. The financial transaction, including the associated value of the prepaid payment card used in the financial transaction, is stored in the database 134.

In the exemplary embodiment, the cardholder mobile device 102 is used to scan a physical prepaid payment card or otherwise input prepaid payment card data, such as an account number, an expiration date, a Card Security Code (CSC), and the like, into the gift bag wallet app 106. With respect to prepaid payment cards, the CSC may also be referred to as a PIN number printed on the prepaid payment card. A Card Security Code (CSC), which may be referred to as a Card Verification Value (CVV or CVV2), Card Verification Value Code (CVVC), Card Verification Code (CVC), Verification Code (V-Code or V Code), or Card Code Verification (CCV) value is a security feature used in payment card transactions for providing increased protection against payment card fraud. Several types of CSC's have been implemented for payment cards. For example, a first type of CSC, for example, a CVC1 or CVV1, is encoded on the magnetic stripe of a payment card and is used in card present transactions. A second type of CSC, for example, a CVC2, CVV2, or card identification number “CID,” is typically requested by a merchant in a CNP transaction. For ease of understanding, the base CVC designation will be used herein when referring to a card security code.

A CVC2 value is a three (3) or four (4) digit number that is printed on a payment card, often on the signature strip, but which is not encoded on the magnetic stripe. Mastercard® branded payment cards, for example, typically include a three (3) digit code. The CVC2 is typically not embossed like a primary account number (PAN) and is typically the final group of numbers printed on the back signature panel of the card. In some applications, the CVC2 appears in a separate panel located to the right of the signature strip. A CVC2 value is typically generated when the payment card is issued by concatenating the PAN, the payment card expiry date, and a service code and hashing under a cryptographic key or keys known only to the issuing bank. Based upon these three (3) inputs and the additional cryptographic keys, the algorithm calculates a resultant ciphertext wherein a portion of the ciphertext is used as the CVC2 value that is printed on the payment card.

After the prepaid payment card is scanned or input into the gift bag wallet app 106, the wallet app communicates prepaid payment card information to the gift bag computing system 110. The gift bag computing system 110 communicates with the prepaid payment card issuer 120 via one of the payment networks, such as the payment networks 112, 114, or 116, to request an available balance of the prepaid payment card. Using the server API described above, the funds transfer application 130 implements a funds transfer API (e.g., the Mastercard Send API, etc.). The funds transfer API includes, for example, and without limitation, services, libraries, computer code, and the like, which enable the funds transfer application 130 to communicate with the payment networks 112, 114, and 116 (e.g., via the payment systems 124, 126, and 128, respectively) and transmit payment messages. The funds transfer API allows the funds transfer application 130 to request or pull funds equal to the balance of the prepaid payment card from the prepaid payment card issuer 120 based on a prepaid payment card funds transfer request received from the gift bag wallet app 106 operating on the cardholder mobile device 102 and transfer those funds to the cardholder's digital wallet 108 (e.g., the account associated with the digital wallet 108).

The funds transfer app 130 (via implementation of the funds transfer API) packages transaction details (e.g., digital wallet details, etc.) into an appropriate message (e.g., an authorization request/response), which is transmitted to and processed by one of the payment networks 112, 114, and 116. Furthermore, the funds transfer app 130 may also facilitate clearing and settlement for the transaction with the cardholder issuer 118 and the prepaid payment card issuer 120. In one suitable embodiment, the funds transfer app 130 transmits a request message that includes data of the prepaid payment card's primary account number (PAN) and the cardholder's digital wallet account information (e.g., account number, account issuer, and the like) to an appropriate payment network. The payment network and the prepaid payment card issuer are identified based on the PAN. The request message is generally in a form of an authorization request message (ISO 8583) capable of payment network transmission. The funds that are associated with the scanned prepaid payment card are retrieved from the prepaid payment card issuer 120 and transferred to the account associated with the cardholder's digital wallet, such as the digital wallet 108, which is held by the cardholder issuer 118. As such, the funds are converted (e.g., redeemed) to a digital wallet account without an expiration date. The cardholder 104 can then use the digital wallet 108 on the cardholder mobile device 102.

The embodiments illustrated and described herein as well as embodiments not specifically described herein but within the scope of aspects of the invention constitute exemplary means for converting a cardholder's prepaid payment cards into a digital wallet card/account not having an expiration date. For example, the cardholder mobile device 102, the gift bag computing system 110, the payment systems 124, 126, and 128, or any other similar computer device(s), specially programmed with computer-executable instructions to execute processes and techniques with a processor as described herein, constitute exemplary means for enabling a cardholder, such as the cardholder 104, to enter prepaid payment card information into the gift bag wallet app 106 and have funds associated with that prepaid payment card transferred to the cardholder's digital wallet card/account, where the funds from multiple prepaid payment cards can be accumulated and aggregated into a single, non-expiring account.

The financial network system 100 described herein is further configured to approve “cardless” electronic transactions made using the digital wallet 108 having the cardholder mobile device 102 “registered” thereto using, for example, wireless communication, unique user account data, and/or the location (e.g., GPS coordinates) of the cardholder mobile device 102. The electronic transaction is cardless in that the cardholder 104 does not have to physically handle a transaction card (e.g., a prepaid payment card) during the electronic transaction. For example, the cardholder 104 receives a prepaid payment card issued by the prepaid payment card issuer 120 and enters registration information into the gift bag wallet app 106 via the cardholder mobile device 102 to register with a payment processing system that enables the cardholder mobile device 102 to electronically initiate cardless electronic transactions. Registration information includes, for example, and without limitation, transaction card information, contact information (e.g., an email address and/or a telephone number), billing information, and/or shipping information. Transaction card information may include, for example, a transaction card or payment account identifier (e.g., a PAN, a partial account number, and/or a card name), a security code, and/or an expiry date. Shipping information may include, for example, a delivery address and/or delivery instruction.

Additionally, the cardholder 104 may provide a biometric sample that is stored in the cardholder mobile device 102. The biometric sample is to be associated with the registration information provided by the cardholder 104 and is used as a single user credential. Biometric samples include, without limitation, a fingerprint image, a voice recording, a retinal image, facial recognition, palm print image, iris recognition, and the like. The biometric sample is unique to the cardholder 104 and is difficult to duplicate and/or forge by an unauthorized user. The biometric sample is stored and associated with a biometric identifier. Additionally, the biometric identifier is associated with the stored registration information and facilitates secure authorization of transactions initiated using any of the registration information. A biometric input device in communication with the cardholder mobile device 102 may be used for the customer to enter the biometric sample. For example, the cardholder mobile device 102 may include an integral fingerprint or palm reader/scanner, retinal or iris reader/scanner, camera, and/or voice reader/recorder.

### Exemplary Computer Systems

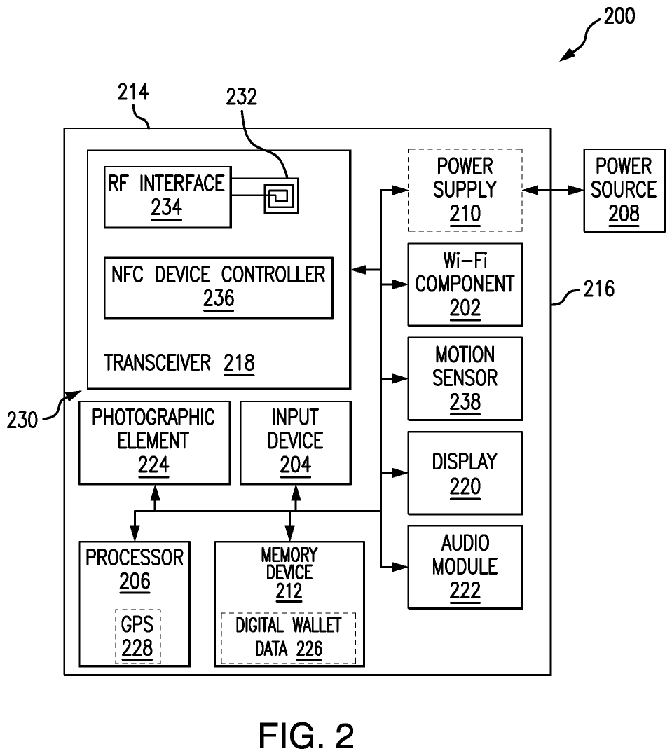

FIG. 2 is an example configuration of a user computing system 200, such as the cardholder mobile device 102 (shown in FIG. 1), that may be operated by a user, such as the cardholder 104 (shown in FIG. 1). In the exemplary embodiment, the computing system 200 is a computing device configured to connect to one or more of the gift bag computing system 110, the issuers 118 and 120, the network 122, the payment systems 124, 126, and 128, and any other computing devices, such as other customer mobile computing devices (not shown).

In the exemplary embodiment, the computing system 200 generally includes a processor 206, a memory device 212, a transceiver 218 (or a wireless communication device), and a photographic element 224. In addition, the computing system 200 includes an integrated Wi-Fi component 202 (e.g., implementing the Institute of Electrical and Electronics/IEEE 802.11 family of standards), an input device 204, a display 220, and an audio module 222. Moreover, the computing system 200 includes an internal power supply 210 (e.g., a battery or other self-contained power source) to receive power, or alternatively, in some embodiments, the computing system 200 may include an external power source 208. Optionally, the computing system 200 may include a motion sensor 238.

The processor 206 includes one or more processing units (e.g., in a multi-core configuration) specially programmed for executing computer readable instructions. The instructions may be executed within a variety of different operating systems (OS) on the cardholder mobile device 102, such as UNIX, LINUX, Microsoft Windows®, etc. More specifically, the instructions may cause various data manipulations on data stored in the memory device 212 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.). The memory device 212 is any device allowing information such as digital wallet data 226, the executable instructions, and/or written works to be stored and retrieved. The memory device 212 includes one or more computer readable media.

In the example embodiment, the processor 206 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

Because the computing system 200 may be widely deployed, it may be impractical to manually update software for each computing system 200. Therefore, the system 100 provides a mechanism for automatically updating the software on the computing system 200. For example, an updating mechanism may be used to automatically update any number of components and their drivers, both network and non-network components, including system level (OS) software components. In some embodiments, the computing system 200 components are dynamically loadable and unloadable; thus, they may be replaced in operation without having to reboot the OS.

A location of the computing system 200 can be obtained through conventional methods, such as a location service (e.g., global positioning system (GPS) service) in the computing system 200, “ping” data that includes geotemporal data, from cell location register information held by a telecommunications provider to which the computing system 200 is connected, and the like. For example, in one suitable embodiment, an optional GPS chip 228 can be part of or separate from the processor 206 to enable the location of the computing system 200 to be determined.

Stored in the memory device 212 are, for example, computer readable instructions for providing a user interface to the user via the display 220 and, optionally, receiving and processing input from the input device 204. A user interface may include, among other possibilities, a web browser and the gift bag wallet app 106 (shown in FIG. 1). Web browsers enable users, such as the cardholder 104, to display and interact with media and other information typically embedded on a web page or a website. The gift bag wallet app 106 allows the cardholder 104 to interact with the gift bag computing system 110 and the payment systems 124, 126, and/or 128 to convert (e.g., redeem) and consolidate prepaid payment card funds into digital wallet funds, which have no expiration date.

The photographic element 224 may include a camera or other optical sensor and lens combination capable of generating a video signal and capturing an image. In various embodiments, the photographic element 224 may be integrated in a housing or body, such as a housing 214, of the computing system 200. When the photographic element 224 captures an image or otherwise generates image data (e.g., video data), the photographic element 224 may store the image data in a data file, either in a raw or compressed format, in the memory device 212.

In some embodiments, the motion sensor 238 may include one or more sensor elements that facilitate detecting a person's presence. For example, if the computing system 200 is operating as the cardholder mobile device 102, the motion sensor 238 detects when the cardholder 104 moves or raises the cardholder mobile device 102. Upon detection of such motion, the photographic element 224 may begin capturing images (e.g., still or video images), the transceiver 218 may be activated, and/or the audio module 222 may begin capturing audio. The motion sensor 238 may be operatively coupled to the photographic element 224 such that the person's presence may be detected by detecting motion using the photographic element 224. The motion sensor 238 may include, for example, and without limitation, sensor elements such as a passive infrared sensor, an ambient light sensor, and the like.

In the example embodiment, the display 220 can include, for example, and without limitation, a liquid crystal display (LCD), an organic light emitting diode (OLED) display, or an “electronic ink” display. In some embodiments, a single component such as a touch screen may function as both an output device (e.g., the display 220) and the input device 204. As such, the display 220 may optionally include a touch controller for support of touch capability. In such embodiments, the computing system 200 may detect a person's presence by detecting that the person has touched the display 220 of the computing system 200.

The audio module 222 may include, for example, and without limitation, a speaker and related components capable of broadcasting streaming and/or recorded audio and may also include a microphone. The microphone facilitates capturing audio through the computing system 200.

In the example embodiment, the computing system 200 includes the housing 214 at least partly (and more preferably, at least substantially or entirely) enclosing the components described above. In addition, the computing system 200 includes circuitry 230 configured to communicate with the network 122 (shown in FIG. 1) and/or other computing devices (e.g., other cardholder mobile devices, the gift bag computing system 110, the payment systems 124, 126, and 128, etc.). The circuitry 230 may include, for example, leads, connectors, NFC-enabled circuitry, Wi-Fi-enabled circuitry, and photographic element circuitry. The housing 214 is preferably configured to seal the circuitry 230, which is susceptible to degradation from the ambient environment. In one embodiment, the circuitry 230 is hermetically sealed in the housing 214. For example, in one embodiment, the circuitry 230 is completely and permanently encased within the housing 214. In other words, the housing 214 and the circuitry 230 are intended to remain as a single, inseparable unit throughout the life of the cardholder mobile device 102. It is understood that the housing 214 can be formed separately from the circuitry 230 and that the circuitry 230 can be placed into and sealed within the housing 214 in a separate operation. It is also understood that the housing 214 can be oversized with respect to the circuitry 230 so that the circuitry 230 can be placed loosely into the housing 214. In another embodiment, the circuitry 230 can be selectively, sealingly enclosed within the housing 214, where the housing 214 includes a closure 216 removably attached to a body of the housing 214.

The housing 214 is fabricated from a suitably selected material that facilitates inhibiting the effect the material has on the signal being emitted from, for example, the transceiver 218 and/or the Wi-Fi component 202 and passing through the housing material. For example, and without limitation, suitable materials from which the housing 214 may be fabricated include polyethylene, propylene, isoprene, and butylenes (i.e., polyolefins). In other embodiments, the housing 214 is fabricated from any material that enables the computing system 200 to function as described herein, such as metals, etc.

In one embodiment, the transceiver 218 includes an antenna 232. The antenna 232 includes a looped wire configured to transmit radio signals when current flows through the looped wire. The antenna 232 is any size, shape, and configuration that is suitable for transmitting signals as described herein. For example, the antenna 232 is a tuned circuit configured to transmit radio signals in any radio-based communication system including, but not limited to, Radio Frequency Identification (RFID), Wireless Local Area Network (WLAN), and Wireless Personal Area Network (WPAN) systems. In the example embodiment, the antenna 232 generates a magnetic field when it vibrates at a selected frequency. Specifically, the antenna 232 is configured to vibrate at a frequency of about 13.56 MHz, which is suitable for use in a near field communication (NFC) system.

In the example embodiment, the antenna 232 transmits radio signals to and receives radio signals from other NFC-enabled computing devices, for example, another cardholder mobile device, merchant point-of-sale (POS) systems (not shown), and/or any other components used in NFC systems. In NFC systems, at least one NFC component generates a magnetic field to inductively transfer currents and, thereby, exchange signals and information with other NFC components positioned within the magnetic field. In the exemplary embodiment, the antenna 232 functions as an NFC component to send and receive signals. The antenna 232 is configured to transmit radio signals to NFC components positioned within the magnetic field of the antenna 232, such as when the cardholder mobile device 102 is located within a predetermined distance of another cardholder mobile device 102 and/or a POS system. Therefore, the magnetic field generated by the antenna 232 defines the active range of the computing system 200. Additionally, the antenna 232 receives radio signals from NFC components when the antenna 232 is positioned within the magnetic field of the NFC components.

The transceiver 218 also includes a radio frequency (RF) interface 234 and an NFC device controller 236. The RF interface 234 and the NFC device controller 236 are powered by the power source 208, and in some embodiments, the internal power supply 210 and/or the display 220. In addition, the processor 206 and the memory device 212 are powered in the same manner. The RF interface 234 is configured to receive and transmit RF signals through the antenna 232. The NFC device controller 236 is configured to process the received RF signals and to generate signals to be transmitted by the RF interface 234. The memory device 212 is configured to store data associated with transmitting and receiving the RF signals. The NFC device controller 236 is coupled in communication with the processor 206.

In some embodiments, the computing system 200 may be connected to one or more peripheral devices (not shown). That is, the computing system 200 may communicate various data with one or more peripheral devices. For example, the computing system 200 may communicate with one or more peripheral devices through the Wi-Fi component 202, the transceiver 218, or other suitable means.

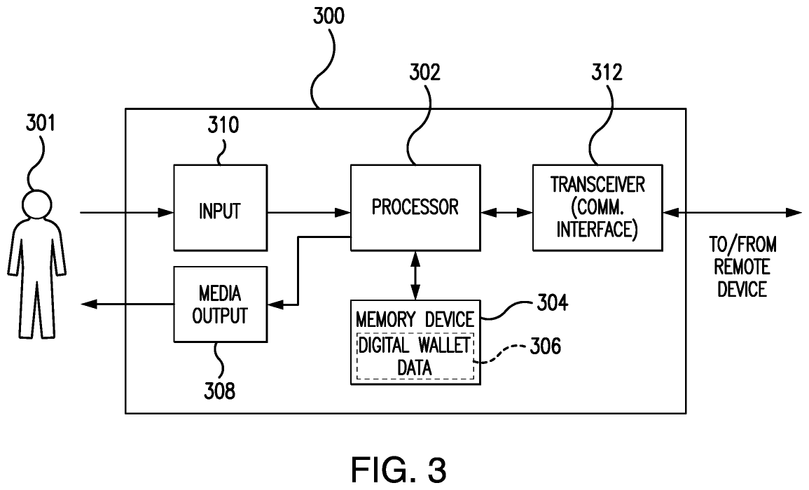

FIG. 3 is an example configuration of a computing system 300 operated by a user 301. In some embodiments, the computing system 300 is a gift bag computing system 110 (shown in FIG. 1), and/or a payment system 124, 126, and/or 128 (shown in FIG. 1).

In the example embodiment, the computing system 300 includes one or more processors 302 for executing instructions. In some embodiments, executable instructions are stored in a memory device 304. The processor 302 may include one or more processing units arranged, for example, in a multi-core configuration. The memory device 304 is any device allowing information such as executable instructions, data, and/or written works to be stored and retrieved. The memory device 304 includes one or more computer readable media.

The computing system 300 also includes at least one media output component 308 for presenting information to the user 301. The media output component 308 is any component capable of conveying information to the user 301. In some embodiments, the media output component 308 includes an output adapter such as a video adapter and/or an audio adapter. An output adapter is operatively coupled to the processor 302 and operatively connectable to an output device such as a display device, a liquid crystal display (LCD), organic light emitting diode (OLED) display, or “electronic ink” display, or an audio output device, a speaker, or headphones.

In some embodiments, the computing system 300 includes an input device 310 for receiving input from the user 301. The input device 310 may include, for example, a touch sensitive panel, a touch pad, a touch screen, a stylus, a photographic element or camera, an optical sensor, a gyroscope, an accelerometer, a position detector, a keyboard, a pointing device, a mouse, or an audio input device. A single component such as a touch screen may function as both an output device of the media output component 308 and the input device 310. The computing system 300 may also include a transceiver 312 (broadly, a communication interface), which is communicatively connectable to a remote device such as the cardholder mobile device 102 (shown in FIG. 1). The transceiver 312 may include, for example, a wired or wireless network adapter or a wireless data transceiver for use with radio frequency communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 304 are, for example, computer readable instructions for providing a user interface to the user 301 via the media output component 308 and, optionally, receiving and processing input from the input device 310. A user interface may include, among other possibilities, a web browser and various software applications. Web browsers enable users to display and interact with media and other information typically embedded on a web page or a website. The various software applications allow the user 301 to interact with the computing system 300 to further communicate with the cardholder mobile device 102, the payment systems 124, 126, and/or 128, etc. to facilitate providing various financial services to the cardholder 104 and, optionally, execute a transaction upon delivery of such services.

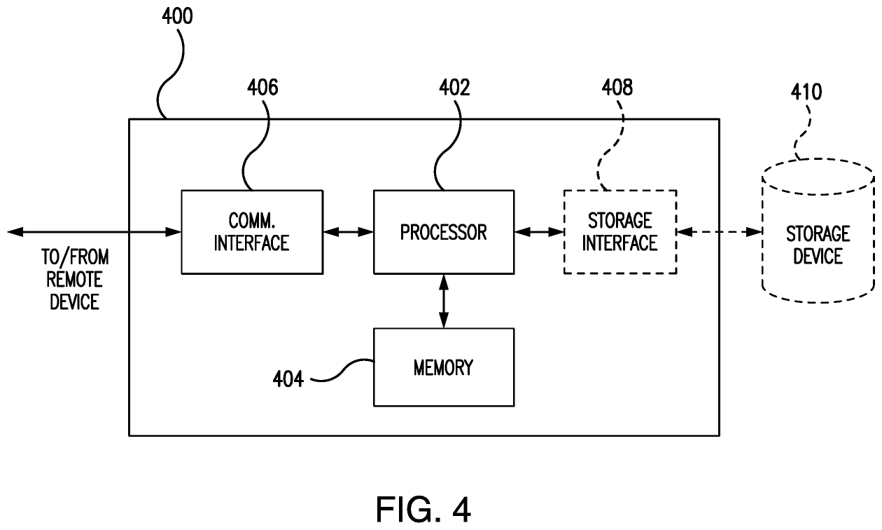

FIG. 4 is an example configuration of a server system 400, such as the database server 132 (shown in FIG. 1). In the example embodiment, the server system 400 includes a processor 402 for executing instructions. The instructions may be stored in a memory area 404, for example. The processor 402 includes one or more processing units (e.g., in a multi-core configuration) for executing the instructions. The instructions may be executed within a variety of different operating systems on the server system 400, such as UNIX, LINUX, Microsoft Windows®, etc. More specifically, the instructions may cause various data manipulations on data stored in a storage device 410 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 402 is operatively coupled to a communication interface 406 such that the server system 400 can communicate with a remote device such as cardholder mobile device 102, a computing system 300, or another server system 400. For example, the communication interface 406 may receive communications from the gift bag computing system 110.

The processor 402 is operatively coupled to the storage device 410. The storage device 410 is any computer-operated hardware suitable for storing and/or retrieving data. In some embodiments, the storage device 410 is integrated in the server system 400. In other embodiments, the storage device 410 is external to the server system 400 and is like the database 134 (shown in FIG. 1). For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 410.

The memory area 404 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

In some embodiments, it is contemplated that the server system 400 is implemented as a software application. In such embodiments, the hardware described above, such as the processor 402, the memory area 404, the communication interface 406, and/or the storage interface 408 may be shared with the hardware components of a computing system 300, such as the processor 302, the memory device 304, and/or the transceiver 312.

### User Interface

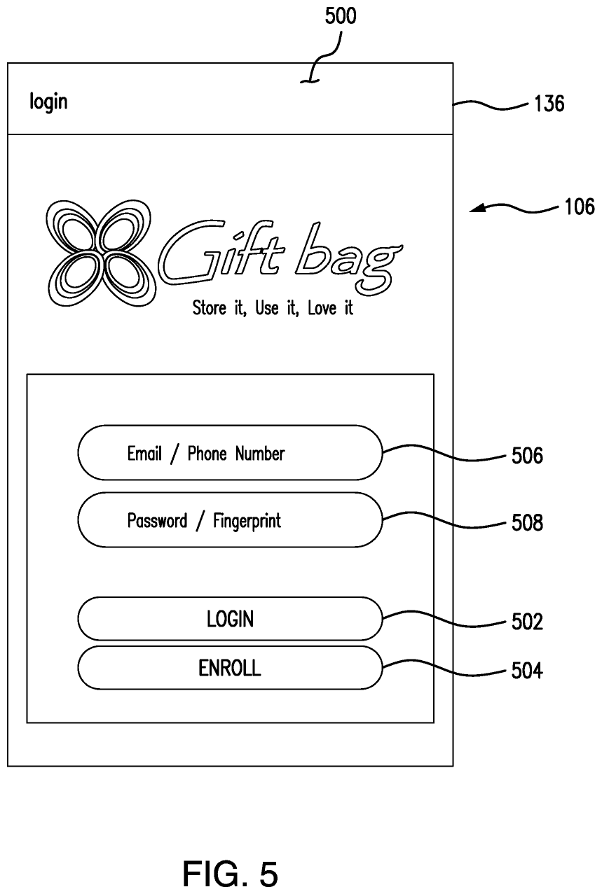

FIG. 5 is a schematic diagram of the user interface 136 of the cardholder mobile device 102, illustrating a login screen 500 presented to the cardholder 104 (shown in FIG. 1) when logging into the gift bag wallet app 106. In the exemplary embodiment, the login screen 500 presents to the cardholder 104 an option for logging into or enrolling in the gift bag wallet app 106. In particular, the login screen 500 includes a first selectable icon (e.g., a “button”) 502 labelled with “LOGIN” and a second selectable icon 504 labelled with “ENROLL.” In addition, the login screen 500 includes a first input box 506 for inputting or entering an email address or phone number (which may function as a user account name) and a second input box 508 for inputting or entering a password associated with the account. The password functions as a user credential. In some embodiments, the cardholder 104 may provide a biometric sample as the user credential, as described above.

After inputting an email address or phone number and a password, the cardholder may press the “ENROLL” icon 504 if the cardholder 104 has not previously setup the gift bag wallet app 106, and therefore, the digital wallet 108. During an enrollment process, the gift bag wallet app will check to see if the cardholder 104 has a digital wallet setup on the cardholder mobile device 102. If so, the gift bag wallet app may utilize the cardholder's digital wallet as the digital wallet 108. Alternatively, if the cardholder 104 does not have a digital wallet, the cardholder 104 may create a new digital wallet through the gift bag wallet app 106. The cardholder 104 may scan a credit card or debit card using the cardholder mobile device 102 to create a digital image of the card. The digital image of the card is analyzed by the cardholder mobile device 102 to identify payment credentials of the card. The payment credentials are transmitted to the card issuer with a request for approval for using the payment credentials to generate a digital wallet. If approved, the associated payment network, such as the payment networks 112, 114, and/or 116, generates a token for the payment credentials and transmits the token to the cardholder mobile device 102. The token is then stored in the newly created digital wallet, which can be an issuer-based digital wallet or a non-issuer-based digital wallet. An issuer-based digital wallet is generally created and controlled by the issuer of the associate payment card/account. In such instances, the issuer has direct access to cardholder account information.

In some instances, the digital wallet generated by the gift bag wallet app 106 is a non-issuer digital wallet, which can hold one or more issuer-based payment cards and/or accounts. A non-issuer digital wallet refers to digital wallets that are not owned and operated by financial institutions but instead are controlled by entities that do not hold a money transfer license. Because every state has its own licensing requirements, there is variability in money transmitter requirements from state-to-state. However, almost every state requires transmitters to satisfy requirements to be licensed as a money transmitter such as securing a surety bond, as well as federal registration requirements with the Financial Crimes Enforcement Network (FinCEN). In addition, money transmitters must be licensed in every state in which transmission activity takes place. Therefore, money transfer licenses can be a significant expense of time and money.

Non-issuer digital wallets do not need money transfer licenses because they do not manage money transfer. There are dozens of non-issuer-based digital wallets including original equipment manufacturer (OEM) based wallets such as Samsung Pay, Apple Pay, Android Pay, etc., as well as other non-issuer wallets such as MasterPass by Mastercard, Google Wallet, Oracle Pay, etc.

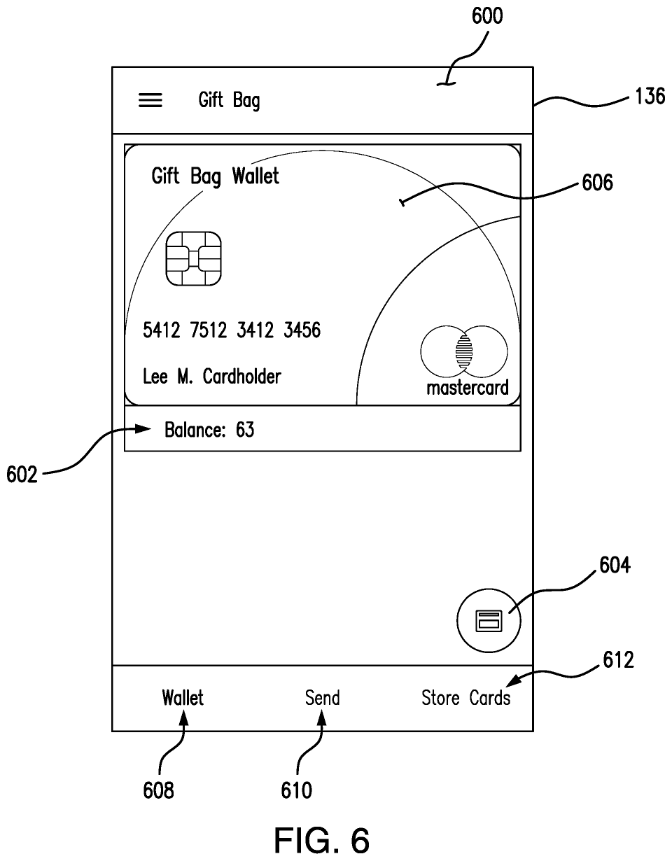

If the cardholder 104 has previously setup the gift bag wallet app 106, and therefore, the digital wallet 108, after inputting an email address or phone number and a password (or submitting a biometric sample), the cardholder may press the “LOGIN” icon 502 to log into the gift bag wallet app 106. The gift bag wallet app 106 verifies that the correct credentials were input before logging into the app and displaying a gift bag screen 600 (shown in FIG. 6).

FIG. 6 is a schematic diagram of the user interface 136 of the cardholder mobile device 102, illustrating the “Gift Bag” screen 600 presented to the cardholder 104 (shown in FIG. 1) after logging into the gift bag wallet app 106. In the exemplary embodiment, the gift bag screen 600 presents to the cardholder 104 a summary of the digital wallet 108 (also referred to herein as the “Gift Bag Wallet”). In one example, the gift bag wallet 108 is represented by an image of a payment card displaying payment account information along with a balance amount 602 available on the gift bag wallet 108. In the illustrated embodiment, the balance amount is sixty-three dollars ($63).

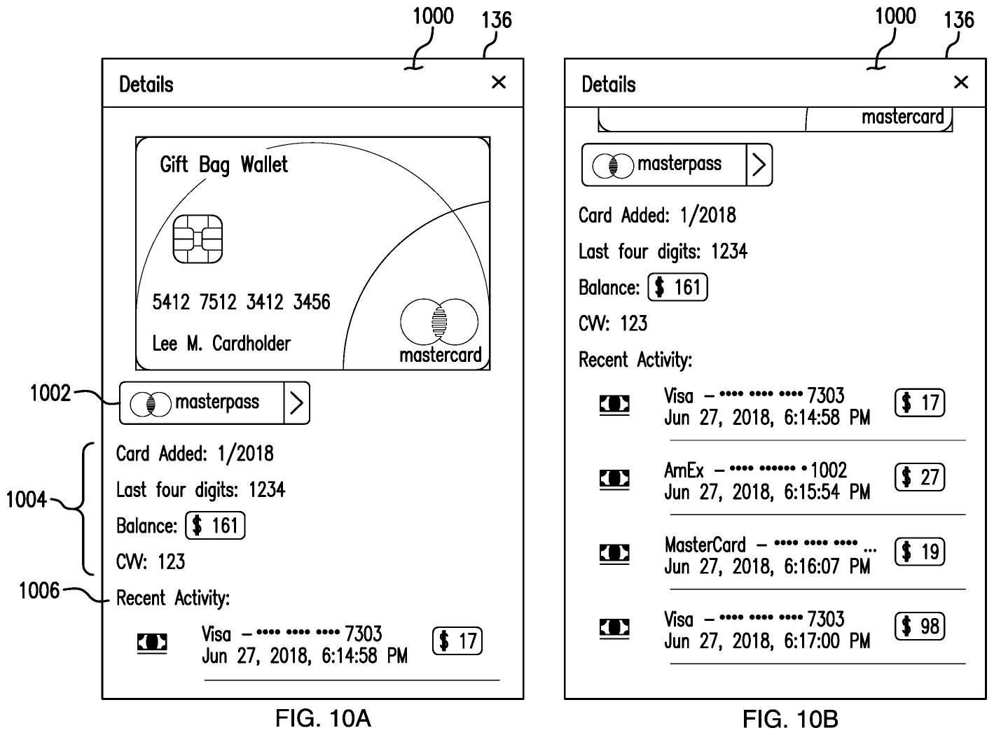

The gift bag screen 600 includes a card scanning icon 604, which when pressed, initiates a card scanning process to add additional prepaid payment cards to the gift bag wallet 108, as discussed below. In addition, the image of the payment card representing the gift bag wallet 108, indicated by reference character 606, can be pressed or touched to open a “Details” screen 1000 (shown in FIGS. 10A and 10B). Furthermore, the gift bag screen 600 includes a plurality of icons distributed across the bottom of the screen area. In particular, the gift bag screen 600 includes a “Wallet” icon 608, a “Send” icon 610, and a “Store Cards” icon 612.

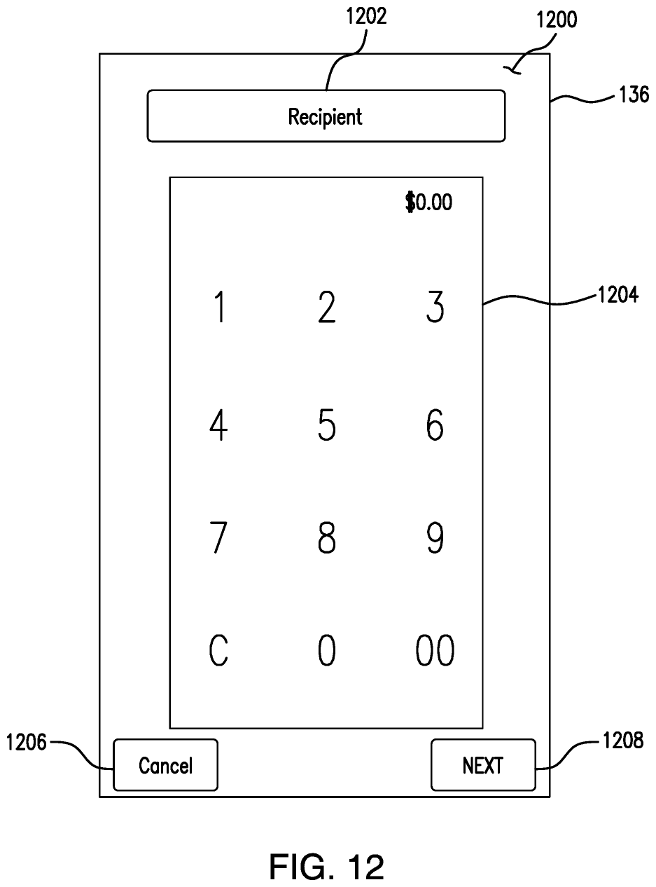

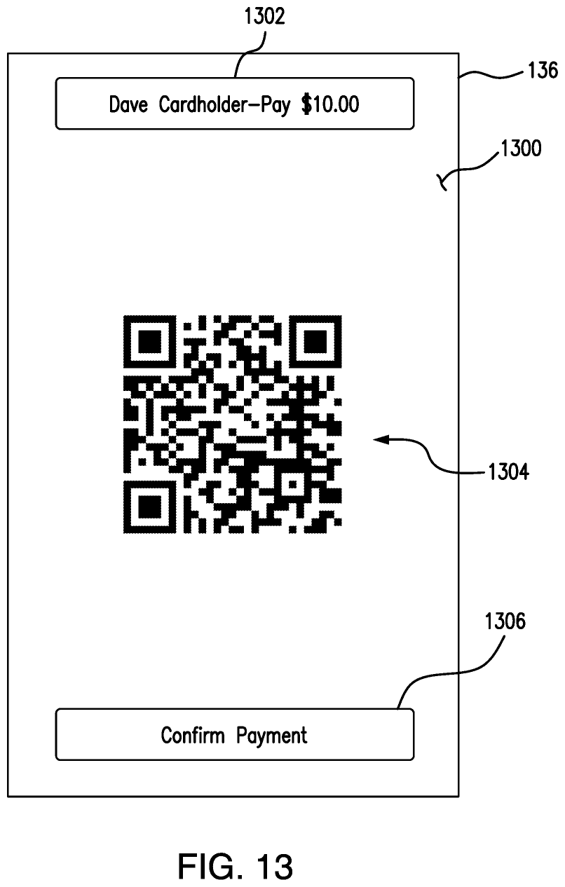

In the exemplary embodiment, the “Wallet” icon 608 can be pressed or touched to present to the cardholder 104 an option to select a digital wallet from a plurality of digital wallets the cardholder 104 may have stored on the cardholder mobile device 102. The “Send” icon 610 can be pressed or touched to present to the cardholder 104 a peer-to-peer payment screen (shown in FIGS. 12 and 13) for making payments to or otherwise transferring funds to another person, whether that person is a digital wallet customer or a non-wallet customer. Furthermore, the “Store Cards” icon 612 can be pressed or touched to present to the cardholder 104 an option to select among various store card prepaid payment cards that the cardholder 104 may have stored on the cardholder mobile device 102. Thus, as described above, the gift bag wallet app 106 can be used to store multiple digital wallets and store card prepaid payment cards in addition to the gift bag wallet 108. With respect to the store card prepaid payment cards capabilities of the gift bag wallet app 106, in certain embodiments, the app 106 can provide an alert to the cardholder 104 (e.g., via a push notification, SMS message, email, and the like) when the GPS coordinates of the cardholder mobile device 102 indicate that the cardholder 104 is proximate a location that accepts one or more of the store card prepaid payment cards.

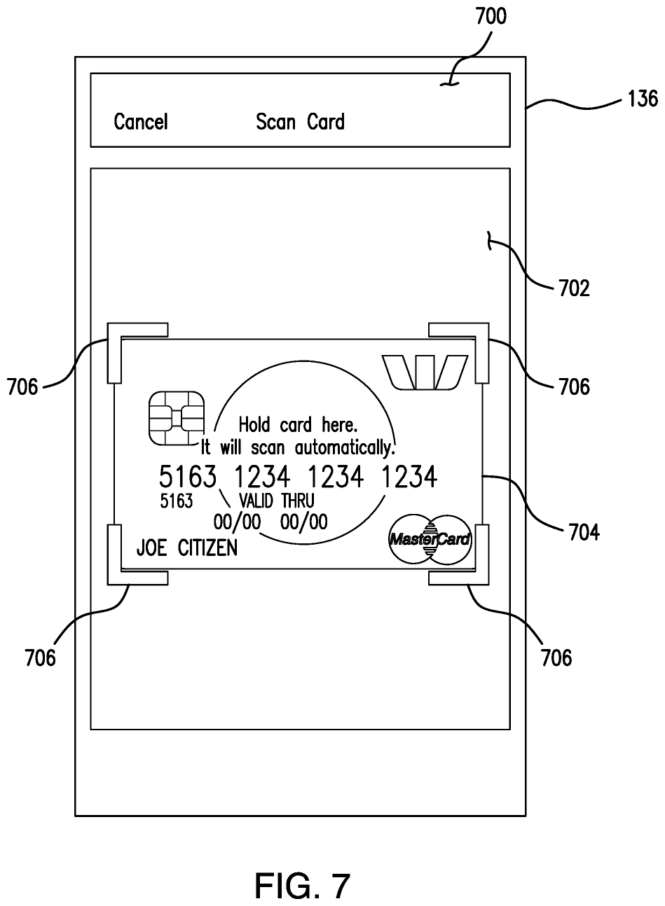

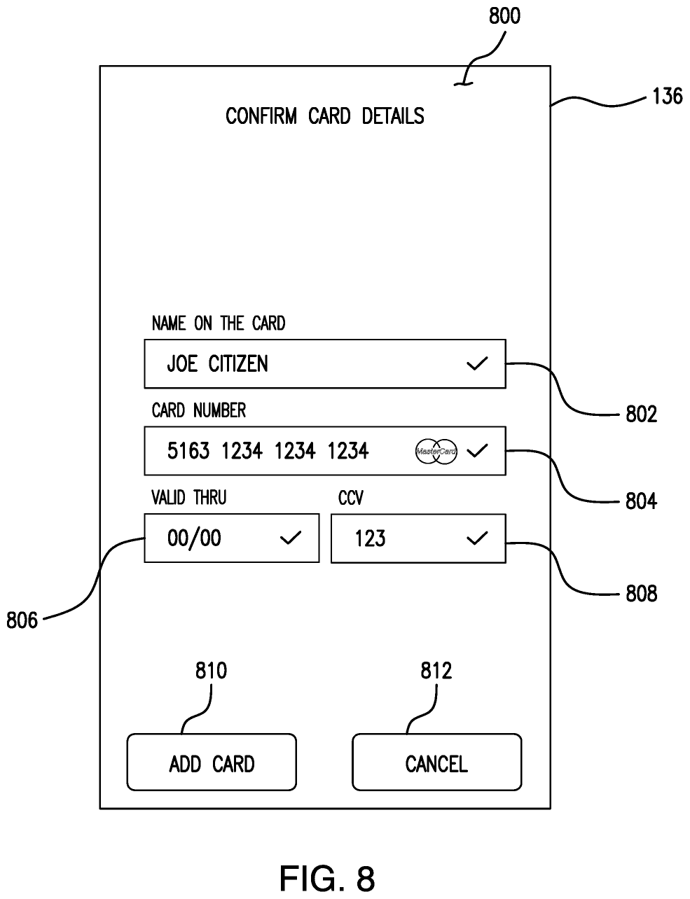

FIG. 7 is a schematic diagram of the user interface 136 of the cardholder mobile device 102, illustrating a “Scan Card” screen 700 presented to the cardholder 104 (shown in FIG. 1) after the cardholder 104 initiates the card scanning process be pressing the card scanning icon 604 (shown in FIG. 6). In the exemplary embodiment, the scan card screen 700 presents to the cardholder 104 a real-time or “live” video stream 702 by activating the photographic element 224 (shown in FIG. 2) of the cardholder mobile device 102. This enables the cardholder 104 to position a physical prepaid payment card 704 in view of the photographic element 224. The cardholder 104 positions the cardholder mobile device 102 and the physical prepaid payment card 704 relative to each other in order to locate the four (4) bounding corner icons 706 at the four (4) corners of the physical prepaid payment card 704. When the physical prepaid payment card 704 is positioned such that its four (4) corners approximately coincide with the bounding corner icons 706, the gift bag wallet app 106 scans the card 704 (using, e.g., one or more feature recognition algorithms) to identify a name on the card (optional), the card number, and the expiration date. After these features are identified by the gift bag wallet app 106, or after a predetermined period has passed, the gift bag wallet app automatically presents to the cardholder 104 a card details screen 800 (shown in FIG. 8).

FIG. 8 is a schematic diagram of the user interface 136 of the cardholder mobile device 102, illustrating the card details screen 800 presented to the cardholder 104 (shown in FIG. 1) after the gift bag wallet app has scanned the physical prepaid payment card 704 (shown in FIG. 7). In the exemplary embodiment, the card details screen 800 presents to the cardholder 104 four (4) input boxes, each of which is automatically filled based on the scan of the physical prepaid payment card 704 or empty (e.g., if the scan failed with respect to that information). The input boxes include a “Name on the Card” box 802, a “Card Number” box 804, a “Valid Thru” box 806 (i.e., the card expiration date), and a “CVV” box 808.

In the exemplary embodiment, the cardholder 104 verifies that the information included in the respective boxes 802, 804, and 806 is correct. If correct, the cardholder 104 can tap on the CVV box 808 and input the CVV value of the physical prepaid payment card 704. Manually inputting the CVV value is typically a requirement for adding a transaction card to a digital wallet. This is to verify that the cardholder has the card in-hand and has not otherwise captured the information (e.g., by skimming the card, online packet sniffing, etc.). The cardholder 104 can also correct or input the appropriate values in the input boxes 802, 804, and 806 if required.

After verifying that the information in the four (4) input boxes 802, 804, 806, and 808 is correct, the cardholder can press or touch an “Add Card” icon 810 presented on the card details screen 800 to add the card value to the gift bag wallet 108. Otherwise, the cardholder 104 can press or touch a “Cancel” icon 812 to cancel the process and return to the gift bag screen 600 (shown in FIG. 6) without adding the prepaid payment card 704 to the gift bag wallet 108.

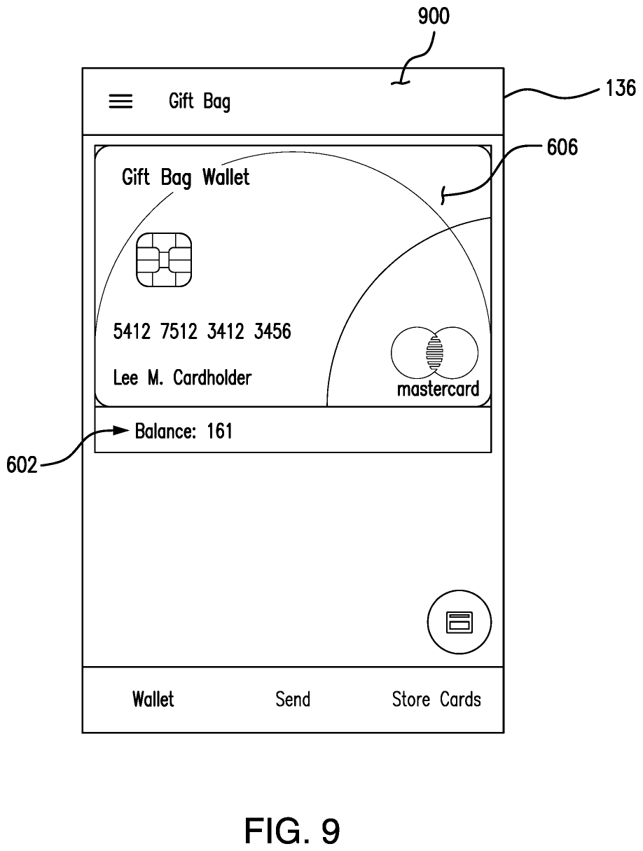

FIG. 9 is a schematic diagram of the user interface 136 of the cardholder mobile device 102, illustrating an updated “Gift Bag” screen 900 presented to the cardholder 104 (shown in FIG. 1) after adding a prepaid payment card, such as the physical prepaid payment card 704 (shown in FIG. 7), to the gift bag wallet 108. In the exemplary embodiment, the updated gift bag screen 900 presents to the cardholder 104 an updated summary of the gift bag wallet 108. As shown in FIG. 9, the balance amount 602 available on the gift bag wallet 108 has been updated to one hundred sixty-one dollars ($161), as opposed to the sixty-three dollars ($63) illustrated in FIG. 6. The cardholder 104 can press or touch the payment card image 606 to open the “Details” screen 1000 (shown in FIGS. 10A and 10B).

FIGS. 10A and 10B are schematic diagrams of the user interface 136 of the cardholder mobile device 102, illustrating the “Details” screen 1000 presented to the cardholder 104 (shown in FIG. 1) after pressing the payment card image 606. In the exemplary embodiment, the details screen 1000 includes the payment card image representing the gift bag wallet 108, a payment icon 1002 for initiating a digital wallet transaction, transaction details 1004 associated with the most recent transaction performed with the gift bag digital wallet 108 (in this instance, the addition of the prepaid payment card 704), and a “Recent Activity” section 1006.

In the exemplary embodiment, the cardholder 104 can scroll through the details screen 1000 to view various transactions listed in the recent activity section 1006. FIG. 10B is an example of the details screen scrolled upward to present the various transactions to the cardholder 104. In the illustrated example, the last transaction is for the addition of ninety-eight dollars ($98) from a Mastercard prepaid payment card (i.e., the physical prepaid payment card 704). As such the ninety-eight dollars ($98) added to the sixty-three dollars ($63) shown in FIG. 6, gives an updated balance of one hundred sixty-one dollars ($161), as illustrated in FIGS. 10A and 10B.

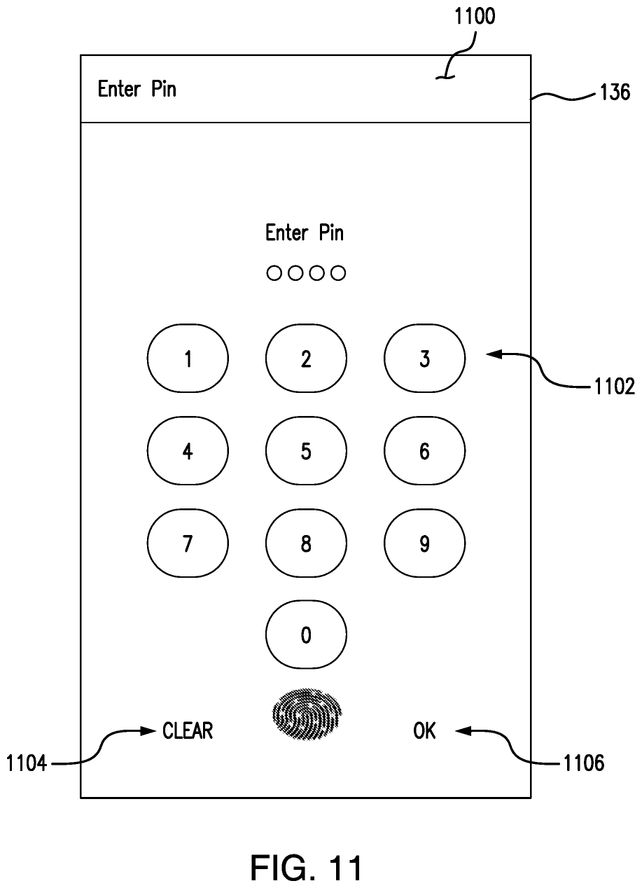

FIG. 11 is a schematic diagram of the user interface 136 of the cardholder mobile device 102, illustrating a PIN screen 1100 presented to the cardholder 104 (shown in FIG. 1) after entering the cardholder's PIN or providing a biometric sample for performing a digital wallet transaction. In the exemplary embodiment, when the cardholder 104 wishes to perform or initiate a digital wallet transaction, for example, to pay a merchant for goods or services, the cardholder presses the payment icon 1002 (shown in FIGS. 10A and 10B) from the details screen 1000. The PIN screen 1100 is then presented to the cardholder 104 and includes a number pad 1102, a “Clear” icon 1104, and an “OK” icon 1106. Upon display of the PIN screen 1100, the cardholder enters his or her PIN using the number pad 1102 or provides a biometric sample, for example, using a biometric input device of the cardholder mobile device 102. If the cardholder incorrectly enters the PIN, he or she can press the “Clear” icon 1104 to start over. If the correct PIN is entered, the cardholder can press the “OK” icon 1106 to process the payment transaction.

FIG. 12 is a schematic diagram of the user interface 136 of the cardholder mobile device 102, illustrating a peer-to-peer (P2P) screen 1200 presented to the cardholder 104 (shown in FIG. 1) for making payments to or transferring funds to another person, in one aspect of the present invention. As described herein with respect to FIG. 6, the cardholder 104 can press the “Send” icon 610 to initiate a P2P transfer of funds. After pressing the “Send” icon 610, the cardholder is presented with the P2P screen 1200, which includes recipient input box 1202, a number pad 1204 for entering a transfer amount, a “Cancel” icon 1206 to cancel the transaction, and a “Next” icon 1208 to continue with the transaction.

The cardholder 104 can press or touch the recipient input box 1202 to input a recipient that is to receive the payment or funds transfer. The user can select a recipient from his or her contacts list and/or enter the recipient into the box directly, for example, by inputting an email address, phone number, and the like. The cardholder inputs an amount to be transferred via the number pad 1204 and presses the “Next” icon 1208 to move to a payment screen 1300 (shown in FIG. 13). Otherwise, the cardholder 104 can press the “Cancel” icon 1206 to end the transaction and return to the details screen 800.

FIG. 13 is a schematic diagram of the user interface 136 of the cardholder mobile device 102, illustrating the payment screen 1300 presented to the cardholder 104 (shown in FIG. 1) after entering payment information into the P2P screen 1200 (shown in FIG. 12), as described above. The payment screen 1300 includes a payment details section 1302 that includes the details of the payment, including for example, the intended recipient of the funds and the amount to be transferred. In addition, the payment screen 1300 includes a quick response (QR) code 1304 that can be scanned to perform the payment transaction. For example, the recipient may scan the QR code 1304 using his or her digital wallet, which can parse account information of the cardholder 104 from the QR code. The QR code 1304 includes information about the cardholder 104 encoded therein, such as a primary account number (PAN), a transaction amount, a transaction currency code, a country identifier, the cardholder's name and address information, optical data fields, CRC checks, and the like. It is contemplated that additional information not specifically described herein may also be incorporated within the QR code 1304 as required.

The payment screen 1300 also includes a “Confirm Payment” icon 1306 that can be pressed or touched to confirm or initiate the payment. For example, if the recipient has a digital wallet and can receive the payment via NFC transmission, pressing the “Confirm Payment” icon 1306 can initiate the NFC transmission of the payment. Likewise, if the recipient is to receive the QR code via email, SMS message, or push message, and the like, pressing the “Confirm Payment” icon 1306 can initiate the transmission of the payment via any of those processes.

### Exemplary Computer-Implemented Methods

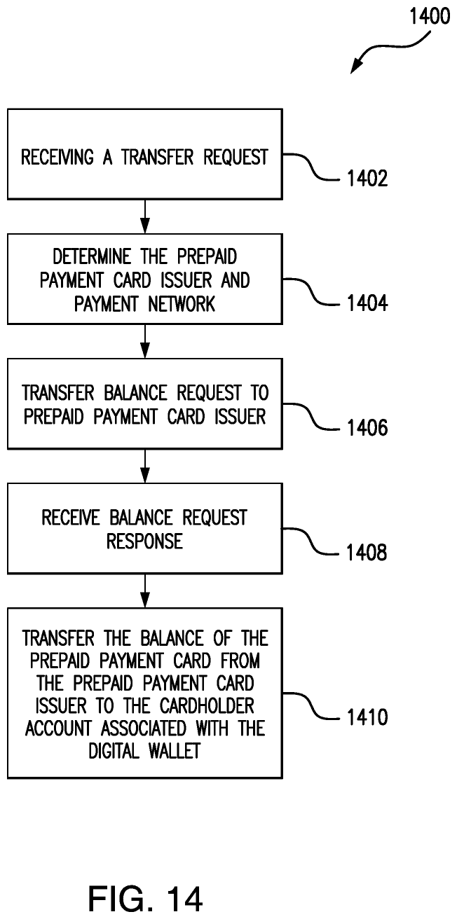

FIG. 14 is a flowchart illustrating an exemplary computer-implemented method 1400 for converting one or more prepaid payment cards into a digital wallet, such as the digital wallet 108 (shown in FIG. 1), not having an expiration date, in accordance with one embodiment of the present disclosure. The operations described herein may be performed in the order shown in FIG. 14 or may be performed in a different order, unless so stated and/or except as will be readily apparent to those skilled in the art from the description. Furthermore, some operations may be performed concurrently as opposed to sequentially. In addition, some operations may be optional.

The computer-implemented method 1400 is described below, for ease of reference, as being executed by exemplary devices and components introduced with the embodiments illustrated in FIGS. 1-13. In one embodiment, the computer-implemented method 1400 may be implemented by one of the payment networks 112, 114, or 116 (shown in FIG. 1) using a computing device, such as the gift bag computing system 110 (shown in FIG. 1). In the exemplary embodiment, the computer-implemented method 1400 relates to transferring funds associated with a prepaid payment card (e.g., redeeming the value of the prepaid payment card) having a fixed expiration date to a cardholder's digital wallet with no expiration date. While operations within the computer-implemented method 1400 are described below regarding the computing system 110, the computer-implemented method 1400 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

In operation 1402, the method 1400 includes receiving, from the gift bag wallet application 106 (shown in FIG. 1) operating on the cardholder mobile device 102 (shown in FIG. 1), a transfer request. The transfer request is for transferring the balance of a prepaid payment card, such as the physical prepaid payment card 704 (shown in FIG. 7), from the prepaid payment card issuer 120 (shown in FIG. 1) of the physical prepaid payment card 704 to a cardholder account associated with the cardholder digital wallet 108 (shown in FIG. 1). As described herein, the gift bag wallet application 106 is configured to receive information about the prepaid payment card 704 from the cardholder 104 (shown in FIG. 1) via the photographic element 224 (shown in FIG. 2) and/or the user interface 136 (shown in FIG. 1) of the cardholder mobile device 102. For example, and without limitation, the gift bag wallet application 106 presents to the cardholder 104, on the display 220 of the cardholder mobile device 102, a real-time video stream (as shown in FIG. 7) by activating the photographic element 224. The cardholder 104 then scans (and/or manually enters) the prepaid payment card 704 and, using one or more feature recognition algorithms, the gift bag wallet application 106 identifies the prepaid payment card information. The prepaid payment card information is then presented to the cardholder 104 (as shown in FIG. 8) on the display 220. The prepaid payment card information includes, for example, a name on the prepaid payment card (optional), a primary account number (PAN) of the prepaid payment card, an expiration date of the prepaid payment card, and a prepaid payment card verification value (CVV).

In operation 1404, the method further includes determining, from the transfer request, the prepaid payment card issuer 120 and a payment network associated with the prepaid payment card, such as one of the payment networks 112, 114, or 116 (shown in FIG. 1). The transfer request includes, for example, and without limitation, cardholder information concerning the cardholder account associated with the digital wallet 108 and the prepaid payment card information described above. To determine the prepaid payment card issuer and the associated payment network, the gift bag wallet application 106 parses the PAN into separate predetermined components. Typically, the first number of the PAN is known as the major industry identifier (MII), which identifies what type of company the card is affiliated with. For example, and without limitation, the company could be an airline, a banking institution, or a retailer. The first number also indicates which payment network the card is associated with for processing, such as American Express® (3), Visa® (4), Mastercard® (5) or Discover® (6). A second group of numbers, typically numbers two (2) through six (6) together with the first number, represent the issuer identification number (IIN), also called the bank identification number (BIN). The IIN or BIN identifies the issuer of the prepaid payment card.

In operation 1406, the method includes transmitting, to the prepaid payment card issuer 120 via the payment network (e.g., payment network 112, 114, or 116), a balance request message for a balance of the prepaid payment card 704. For example, and without limitation, the gift bag computing system 110 (shown in FIG. 1) transfers a balance inquiry to the identified prepaid payment card issuer 120 via the appropriate payment network. The balance inquiry typically consists of an authorization request message with a value of thirty (30) in data element three (DE 3), subfield one (1) of authorization messages. It is noted that the messages within a payment network, may, in at least some instances, conform to the International Organization for Standardization (ISO) Standard 8583, Financial transaction card originated messages—Interchange message specifications, which is the ISO standard for systems that exchange electronic transactions made by cardholders using payment cards. In the example embodiment, the authorization request message can be an ISO 8583 message type identifier (MTI) “0100” message.

In operation 1408, the method includes receiving, from the prepaid payment card issuer 120 via the payment network (e.g., payment network 112, 114, or 116), a balance request response message identifying the balance of the prepaid payment card 704. For example, and without limitation, the gift bag computing system 110 (shown in FIG. 1) receives a balance inquiry response message from the prepaid payment card issuer 120 via the appropriate payment network. The balance inquiry response message typically consists of an authorization response message that includes the balance of the account associates with the prepaid payment card 704. In the example embodiment, the authorization response message can be an ISO 8583 message type identifier (MTI) “0110” message.

In operation 1410, the method includes transferring the balance of the prepaid payment card 704 from the prepaid payment card issuer 120 to the cardholder account associated with the digital wallet 108 via the payment network. In particular, the method includes the gift bag computing system 110 packaging transaction details into an appropriate request message, such as payment authorization request message (MTI 0100 message). The transaction details are based on transaction information included in the transfer request, as described above. Furthermore, in operation, 1412, the gift bag computing system 110 transmits the request message to the prepaid payment card issuer 120 via the payment network, and at operation 1414, receives a response message (e.g., an MTI 0110 message) from the prepaid payment card issuer 120. The response message includes an approval authorizing the transfer of the balance of the prepaid payment card based on the transaction details included in the request message. As described herein, the transfer of funds from the prepaid payment card issuer 120 to the cardholder issuer 118 (shown in FIG. 1) are performed by an application programming interface (API) executing on the gift bag computing system 110. The API implements services and interfaces that enable the gift bag computing system 110 to communicate with the prepaid payment card issuer 120 and the cardholder issuer 118 of the account associate with the cardholder's digital wallet 108, via the appropriate payment network.

It is noted that for additional prepaid payment cards, the method 1400 described above can be repeated. For example, for a second prepaid payment card, the funds may be transmitted to the cardholder's digital wallet 108 in substantially the same manner, wherein the additional funds are aggregated together within the digital wallet account.

As is understood from the above described method 1400, the cardholder 104 can transfer funds from a physical prepaid payment card, such as the prepaid payment card 704, to his or her digital wallet 108. Most prepaid payment cards have an expiration date associated with the prepaid payment card, and in some instances, monthly fees associated with maintaining the account for a certain period. An advantage of transferring the prepaid payment card funds to the cardholder's digital wallet includes eliminating such fees and avoiding the expiration of the prepaid payment card funds.

### ADDITIONAL CONSIDERATIONS

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated, unless so stated and/or except as will be readily apparent to those skilled in the art from the description. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A computing system comprising:
a communication interface for receiving, from a gift bag wallet application operating on a cardholder mobile device, a first transfer request to transfer a balance of a first prepaid payment card from a first prepaid payment card issuer of said first prepaid payment card to a cardholder account associated with a cardholder digital wallet; and
one or more processors programmed to:
determine, from the first transfer request, the first prepaid payment card issuer and a first payment network associated with the first prepaid payment card;
using the communication interface, transmit, to the first prepaid payment card issuer via the first payment network, a first balance request message for a balance of the first prepaid payment card;
receive, from the first prepaid payment card issuer via the communication interface, a first balance request response message identifying the balance of the first prepaid payment card; and
transfer, using the communication interface, the balance of the first prepaid payment card from the first prepaid payment card issuer to the cardholder account associated with the cardholder digital wallet via the payment network based on cardholder information of the cardholder account included in the first transfer request.

2. The computing system in accordance with claim 1,
said one or more processors programmed to transfer the balance of the first prepaid payment card by implementing a funds transfer application programming interface (API) executing on the computing system.

3. The computing system in accordance with claim 1,
said one or more processors programmed to:
package transaction details into an appropriate request message, the transaction details based on transaction information included in the first transfer request; and
transmit the appropriate request message to the first prepaid payment card issuer via the first payment network.

4. The computing system in accordance with claim 3,
the transaction details including one or more of the following: data of a primary account number (PAN) of the first prepaid payment card and cardholder digital wallet account information.

5. The computing system in accordance with claim 3,
the appropriate request message being in the form of an ISO 8583 authorization request message.

6. The computing system in accordance with claim 3,
said one or more processors further programmed to receive, via the communication interface, a response message, the response message approving the transfer of the balance of the first prepaid payment card based on the transaction details included in the appropriate request message.

7. The computing system in accordance with claim 1,
said communication interface configured to receive from the gift bag wallet application, a second transfer request to transfer a second balance of a second prepaid payment card from a second prepaid payment card issuer of said second prepaid payment card to the cardholder account associated with the cardholder digital wallet; and
said one or more processors further programmed to:
determine, from the second transfer request, the second prepaid payment card issuer and a second payment network associated with the second prepaid payment card;
using the communication interface, transmit, to the second prepaid payment card issuer via the second payment network, a second balance request message for a balance of the second prepaid payment card;
receive, from the second prepaid payment card issuer via the communication interface, a second balance request response message identifying the balance of the second prepaid payment card; and
transfer, using the communication interface, the balance of the second prepaid payment card from the second prepaid payment card issuer to the cardholder account associated with the cardholder digital wallet via the second payment network, the balance of the first and second prepaid payment cards being aggregated together within the cardholder account associated with the cardholder digital wallet.

8. A system comprising:
a cardholder mobile device comprising:
a transceiver;
a photographic element;
a memory device for storing a gift bag wallet application and a digital wallet thereon;
a display for presenting a user interface to a cardholder; and
a first processor coupled in communication to said transceiver, said photographic element, said memory device, and said display, said first processor programmed to execute the gift bag wallet application, the gift bag wallet application having a user interface; and
a computing system comprising:
a communication interface for receiving, from said cardholder mobile device, a transfer request to transfer a balance of a prepaid payment card to a cardholder account associated with the digital wallet; and
a second processor programmed to:
determine, from the transfer request, a prepaid payment card issuer and a payment network associated with the prepaid payment card;
package prepaid payment card information and transaction details received in the transfer request into an authorization request message;
transmit, via the payment network using the communication interface, the authorization request message to the prepaid payment card issuer via the payment network; and
transfer, via the payment network using the communication interface, the balance of the prepaid payment card from the prepaid payment card issuer to the cardholder account associated with the digital wallet.

9. The system in accordance with claim 8,
said second processor programmed to transfer the balance of the prepaid payment card by implementing a funds transfer application programming interface (API) executing on the computing system.

10. The system in accordance with claim 8,
the prepaid payment card information including data of a primary account number (PAN) of the prepaid payment card,
the transaction details including digital wallet account information associated with the digital wallet.

11. The system in accordance with claim 8,
said first processor programmed to receive the prepaid payment card information from a cardholder via one or more of the following: the photographic element and the user interface.

12. The system in accordance with claim 11,
said first processor programmed to:
present to the cardholder, on the display, a real-time video stream by activating the photographic element of the cardholder mobile device;
scan the prepaid payment card using one or more feature recognition algorithms configured to identify the prepaid payment card information; and
present to the cardholder, on the display, the prepaid payment card information in a card details screen.

13. The system in accordance with claim 12,
said first processor further programmed to receive from the cardholder, via the user interface, a prepaid payment card verification value (CVV).

14. The system in accordance with claim 11,
the prepaid payment card information comprising one or more of the following: a name on the prepaid payment card, a primary account number of the prepaid payment card, an expiration date of the prepaid payment card, and a prepaid payment card verification value (CVV).

15. A method comprising:
receiving, from a gift bag wallet application operating on a cardholder mobile device, a transfer request to transfer a balance of a prepaid payment card from a prepaid payment card issuer of the prepaid payment card to a cardholder account associated with a cardholder digital wallet;
determining, by a computing system from the transfer request, the prepaid payment card issuer and a payment network associated with the prepaid payment card;
transmitting, by the computing system to the prepaid payment card issuer via the payment network, a balance request message for a balance of the prepaid payment card;
receiving, by the computing system from the prepaid payment card issuer, a balance request response message identifying the balance of the prepaid payment card; and
transferring the balance of the prepaid payment card from the prepaid payment card issuer to the cardholder account associated with the cardholder digital wallet via the payment network based on cardholder information of the cardholder account included in the transfer request.

16. The method of claim 15,
the operation of transferring the balance of the prepaid payment card comprising implementing a funds transfer application programming interface (API) executing on the computing system.

17. The method of claim 15 further comprising:
packaging transaction details into an appropriate request message, the transaction details based on transaction information included in the transfer request; and
transmitting the appropriate request message to the prepaid payment card issuer via the payment network.

18. The method of claim 17,
the transaction details including one or more of the following: data of a primary account number (PAN) of the prepaid payment card and cardholder digital wallet account information.

19. The method of claim 17,
the appropriate request message being in the form of an ISO 8583 authorization request message.

20. The method of claim 17 further comprising receiving a response message, the response message approving the transfer of the balance of the prepaid payment card based on the transaction details included in the appropriate request message.
